(19) United States
(12) Patent Application Publication
(10) Pub. No.: US 2013/0045899 A1
(43) Pub. Date: Feb. 21, 2013

(54) Compositions And Methods To Stabilize Acid-In-Oil Emulsions

(71) Applicants: Oscar Bustos, Trophy Club, TX (US); Mathew Samuel, Sugar Land, TX (US); Frank Chang, Al-Khobar (SA); Leiming Li, Sugar Land, TX (US)

(72) Inventors: Oscar Bustos, Trophy Club, TX (US); Mathew Samuel, Sugar Land, TX (US); Frank Chang, Al-Khobar (SA); Leiming Li, Sugar Land, TX (US)

(73) Assignee: SCHLUMBERGER TECHNOLOGY CORPORATION, Sugar Land, TX (US)

(21) Appl. No.: 13/254,872

(22) PCT Filed: Nov. 3, 2010
(86) PCT No.: PCT/IB10/54987

§ 371 Date: Oct. 24, 2012

Related U.S. Application Data
(60) Provisional application No. 61/260,670, filed on Nov. 12, 2009.

(30) Foreign Application Priority Data
Mar. 31, 2010 (US) 12/751596

(51) Int. Cl. C09K 8/72; B82Y 99/00

(52) U.S. Cl. 507/204; 507/203; 507/260; 507/263; 507/267; 977/762; 977/773

(57) ABSTRACT

A method and apparatus for treating a subterranean formation traversed by a wellbore including forming an emulsion comprising oil, acid, and particulate, wherein the forming the emulsion is prepared on the fly, and introducing the emulsion into a wellbore.

### BACKGROUND

The statements in this section merely provide background information related to the present disclosure and may not constitute prior art.

Emulsified acid is a desirable fluid in the treatment of oil and gas wells, such as acidizing, stimulating, and/or hydraulic fracturing treatments, because it facilitates the formation of wormholes and prevents gross degradation of the formation. Stabilized emulsions are especially desirable because they act as retarded acids.

Generally, acid emulsions are manufactured by mixing and shearing between 50 to 80 percent acid (most common is 70 percent) and anywhere between 50 to 20 (most common is 30 percent) percent oil composition (commonly crude oil or diesel are the most widely fluids used, with small amounts of emulsifiers and other additives in a batch system. Historically, optimizing the batch mixing of an acid into oil has been the preferred method to stabilize the emulsion. The use of a batch mixing process helps provide sufficient mixing shear to stabilize the emulsion. The batch mixing process requires time, disposal and neutralization of material that collects in the bottom of the batch mixing tank. Historically, attempts to use a rapid mixing system, such as on-the-fly mixing, result in less stable emulsions that break into oil and acid. A process that is more efficient and that does not require a batch mixer or disposal of material that is retained in the batch mixer is needed.

### SUMMARY

Embodiments of the invention relate to a method and apparatus for treating a subterranean formation traversed by a wellbore including forming an emulsion comprising oil, acid, and particulate, wherein the forming the emulsion is performed on the fly, and introducing the emulsion into a wellbore. In some embodiments, the particulate is derived from a plant. In some embodiments, the acid comprises chelant-based acid system, organic acids, or a combination thereof or the acid comprises hydrofluoric, hydrochloric, formic, acetic, maleic, citric, or cinnamic acid or a combination thereof. In some embodiments, the oil is diesel, kerosene, mineral oil, paraffin oil, vegetable oil, LPG, crude oil, benzene, xylene, toluene, or a mixture thereof. In some embodiments, forming the emulsion is performed with a residence time of 30 seconds or less. In some embodiments, the emulsion is partially created on the fly or fully created on the fly.

### DETAILED DESCRIPTION

At the outset, it should be noted that in the development of any actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the compositions used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration or amount range listed or described as being useful, suitable, or the like, is intended that any and every concentration or amount within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all points within the range are to be considered to have been specified, and that inventors possessed knowledge of the entire range and all points within the range.

Embodiments include compositions and methods to stabilize acid-in-oil emulsions for matrix and acid fracture treatments to allow one to mix and pump the emulsions continuously on the fly. Embodiments of the invention use methods of continuously mixing and pumping the emulsion into a well by bull heading or by using a coiled tubing.

In some embodiments, an emulsion is stabilized by using water miscible nano and micro particulates added to the system as a colloid, slurry, or solid. In some other embodiments, these degradable solids add a benefit of diverting acid for zone coverage in the reservoir whereas at the surface they serve as emulsion stabilizing agents. They also lower the loss of treatment fluid to the formation.

In some embodiments, the particulate is derived from a plant, such as a nut powder or a grain powder. For example, nutmeg, mustard, or guar may be selected. Oil seed particulates (preferably powder) may be used as fines to increase the stability and rate of formation of emulsions. Oil seed powders (any plant originated carbohydrate based powders work) have several advantages. Particulates that are soluble under reservoir temperature, pressure, and chemical conditions but are insoluble at surface conditions may be useful for creating stabilized emulsions.

These materials may be water soluble or oil soluble; or the material may be an encapsulated water soluble material which can be slurried in oil, essentially preventing the material from substantially mixing with acid. After entering the formation, the removal of encapsulation due to temperature and/or pressure allows the material to be dissolved. Similarly, the material is an encapsulated oil soluble material which can be slurried in water, the material does not come in contact with oil during mixing, but after it enters the formation, the removal of encapsulation due to temperature, pressure, and/or time allows the material to be dissolved. In some cases, the materials are not soluble in acid but as the acid is spent, the material becomes soluble in water, such as benzoic acid particulates, EDTA, and the like.

Some of the above mentioned dissolvable solids may also add a benefit of diverting acid for zone coverage in the reservoir, whereas on surface they serve as emulsion stabilizing agents.

Emulsions are stabilized by using water miscible nano and micro particulates, added to the system as a colloid, slurry, or as solid. In some embodiments, particulates that are soluble under reservoir temperature, pressure, and chemical conditions but insoluble at surface condition are candidates for creating stabilized emulsion. The materials might be water soluble or oil soluble.

In some embodiments, the material is an encapsulated water soluble material which can be slurried in oil. The encapsulated material does not come in contact with acid, but after it enters the formation, the removal of encapsulation due to temperature or pressure allows the material to be dissolved. Similarly, in some embodiments, a material is an encapsulated oil soluble material which can be slurried in water, the material does not come in contact with oil during mixing, but after it enters the formation, the removal of encapsulation due to temperature or pressure allows the material to be dissolved. Some embodiments may benefit from the use of encapsulated oil soluble materials to stabilize acid-in-oil emulsion. The material may be an encapsulated oil soluble resin or an encapsulated water soluble inorganic material, such as soluble salts of Groups 1 and 2 metals, soluble salts of other metals, NH₄, and ammonium salts and organic materials such as carbohydrates and organic acids.

In some embodiments, the materials are not soluble in acid, but as the acid is spent, the material becomes soluble in water, such materials include organic acids and their derivatives including acid polymers and chelating agents. In some embodiments, the dissolvable solids add a benefit of diverting acid for zone coverage in the reservoir whereas on surface they serve as emulsion stabilizing agents.

Some embodiments may benefit from the use of water miscible nano and micro particulates, in the form of wires or tubes to stabilize the acid-in-oil emulsion for the treatment of carbonates. In some embodiments, water miscible materials are isomers or copolymers of PLA, PGA, and modified versions such as PLA-ECL (PLA-Epsilon Caprolactom).

In some embodiments, the water miscible materials are pre-treated. In some embodiments, the water miscible materials are partially or completely miscible in water depending on the temperature, pH, salinity and the presence of other additives. In some embodiments, the soluble material is fatty acid esters or metal salts of fatty acid.

In some embodiments, the oil is diesel, kerosene, mineral oil, vegetable oil, LPG, or crude oil. In some embodiments, the oil is pretreated with polymers or surfactants.

Other additives in the formulation include emulsifier, iron control agents, H₂S scavenger, fiber, fluid loss additives, friction reducers, tacky additives, consolidating materials, scale control additives, wettability alternating additives, etc.

Other benefits of these materials include:

1. They can increase the rate in which emulsions are formed. This will allow one to make acid emulsions quickly on the fly rather than batch mixing.
2. This will allow a user to mix acid emulsions on the fly rather than the batch processing, saving time and HSE concerns.
3. The fine particles used to stabilize the emulsion can increase the viscosity of the acid emulsions.
4. Viscosity increase can lower leakoff of the acid and thus increase efficiency.
5. Also, the fine particulate can build filtercake, and, thus, further reduce leakoff.
6. Lower leakoff allows a user to pump acid at low rates (resulting in low friction).
7. Lower pump rates requires less pumps on the surface, lowering the cost.
8. The nut powder is cellulose-based and will degrade completely to simple sugars.
9. Can be used in matrix stimulation and fracturing.
10. Use of fibers or other particulates (dissolvable or not) can further reduce leakoff and provide diversion.

Embodiments of the invention relate to a method and apparatus for treating a subterranean formation traversed by a wellbore including forming an emulsion comprising oil, acid, and particulate, wherein the forming the emulsion is performed on the fly, and introducing the emulsion into a wellbore. In some embodiments, the introducing the emulsion comprises bull heading or using coiled tubing. In some embodiments, forming the emulsion is performed with a residence time of 30 seconds or less. The emulsion may be partially created on the fly or fully created on the fly.

In some embodiments, the particulate is derived from a plant, such as nut powder or a grain powder, and/or nutmeg, mustard, guar, or a combination thereof. In some embodiments, the particulate is a partially soluble organic acid or poly organic acid. In some embodiments, the particulate is PLA, PGA, benzoic acid, citric acid, or a combination thereof. In some embodiments, the particulates are water miscible nano and/or micro particulates. In some embodiments, the particulates are in the form of wires or tubes. In some embodiments, the particulates comprise polymers including PLA, PGA, modified versions PLA or PGA, their optical active isomers, recemic mixtures or combinations thereof. In some embodiments, the particulates are fatty acid esters or metal salts of fatty acid.

In some embodiments, the acid comprises chelant-based acid system, organic acids, or a combination thereof. In some embodiments, the acid comprises hydrofluoric, hydrochloric, formic, acetic, maleic, citric, or cinnamic acid or a combination thereof.

In some embodiments, the oil is diesel, kerosene, mineral oil, paraffin oil, vegetable oil, LPG, crude oil, benzene, xylene, toluene, or a mixture thereof.

In some embodiments, the particulates comprise encapsulated oil soluble materials. The materials may be encapsulated oil soluble resins or encapsulated water soluble materials. In some embodiments, the materials are soluble salts of Groups 1 and 2 metals, other metals, NH₄, and ammonium, or a combination thereof. In some embodiments, the materials are organic materials, such as carbohydrates and organic acids. In some embodiments, the materials are pre-treated.

In some embodiments, the oil is pretreated with polymers, surfactants, emulsifiers, or a combination thereof. In some embodiments, the oil is pretreated with corrosion inhibitors. The corrosion inhibitor may comprises inhibitor aids or may not comprise an inhibitor aid. In some embodiments, the emulsion may benefit from including emulsifiers, iron control agents, H₂S scavenger, fiber, fluid loss additives, friction reducers, tacky additives, consolidating materials, scale control additives, wettability alternating additives, or combinations thereof.

The following examples serve to further illustrate the invention.

### EXAMPLES

### Example 1

An acid emulsion is prepared with the following composition:

Acid: 15% HCl solution: 69.5% or 695 gpt

Corrosion Inhibitor: 1 gpt

Diesel: 30% or 300 gpt

AQUET 942 Emulsifier: 4 gpt

The acid containing the corrosion inhibitor is added in drops to the diesel containing the emulsifier in a Warring blender. The fluid is blended for 5 min at low speed and measured the viscosity on a Fann 35. The result is summarized in Table 1 below

### Example 2

Similar experiment was conducted where a 2% nutmeg was added while blending. Viscosity of the emulsion was examined on a Fann 35:

TABLE 1
Viscosity of emulsified acid with and without the nutmeg powder

| | |
|---|---|
| Fann 35 Dial Reading | RT Viscosity |

| Acid System | 100 RPM | 300 RPM | at 170 S−1 |
|---|---|---|---|
| Emulsion | 30 | 61 | 90 |
| Emulsion + Nutmeg | 40 | 81 | 120 |

### Example 3

In this example, the acid containing the corrosion inhibitor is added quickly (in 30 sec) to the diesel containing the emulsifier in a Warring blender. Then taking a small amount of this fluid using a medicine dropper and pouring into a beaker containing water every 10 seconds (Table 2). If the droplets were intact or formed a snake like structure, it was deemed oil external. If the droplets dispersed into the water, this indicated the absence of an oil external emulsion:

TABLE 2
The rate at which an oil external emulsion is formed

| | External phase in the emulsion (W = Water and O = Oil) | | | | | | |
|---|---|---|---|---|---|---|---|
| | 0 | 10 | 20 | 30 | 40 | 50 | 60 |
| Acid System | Sec | sec | sec | sec | sec | sec | sec |
| Emulsion | W | W | W | W | O | O | O |
| Emulsion + | W | W | O | O | O | O | O |
| Nutmeg | | | | | | | |

The ‘Emulsion’ requires about 50 seconds to form the oil external emulsion where as it requires only 20 seconds for emulsification in the presence of nutmeg powder.

### Example 4

The acid containing the corrosion inhibitor is added quickly (in 30 sec) to the diesel containing the emulsifier in a Warring blender. Take a small amount of this fluid using a medicine dropper and pour that in a beaker containing water every 10 seconds (Table 3). If the droplets are intact or it forms a snake like structure, it is oil external. If the droplets disperse into the water indicate the absence of an oil external emulsion.

TABLE 3
The rate at which an oil external emulsion is formed.

| | External phase in the emulsion (W = Water and O = Oil) | | | | | | |
|---|---|---|---|---|---|---|---|
| | 0 | 10 | 20 | 30 | 40 | 50 | 60 |
| Acid System | Sec | Sec | Sec | Sec | Sec | Sec | Sec |
| Emulsion | W | W | W | W | W | O | O |
| Emulsion + | W | W | O | O | O | O | O |
| Guar Powder | | | | | | | |

The emulsion requires about 50 seconds to form the oil external emulsion where as it requires only 20 seconds for emulsification in the presence of guar powder (0.5-2%).

Kerosene (1.57 cp and 780 kg/m³) and MULTITHERM-PG1™ oil (43 cp and 873 kg/m³ @ 20° C.) (a heat transfer oil commercially available from MultiTherm of Malvern, Pa.) were used as the oil phase to form an emulsion. Flow rate of adding the aqueous phase was 7 cc/min. After making the emulsion, it was mixed for 10 minutes. Emulsion stability of the system was monitored using a bottle test. Effect of the addition of two different stabilizers was investigated separately. Those stabilizers are known as polylactide fiber and polylactide beads. Such results were compared with emulsion made without stabilizer. Emulsions have the following components:
30 ml of oil (Kerosene or MULTITHERM-PG1™ oil)
0.5 g stabilizer (when stabilizer was used)
0.4 ml emulsifier comprising an organic acid in solvents comprising surfactant
70 ml of aqueous phase (15% HCl)

Stability results when kerosene was used as the oil phase show that fiber and beads work almost equally as well as a stabilizers over the first 3 hours. Phase separation was monitored after 1, 2, 3 and 24 hrs for all the tested emulsions. The fiber did not perform as well as the beads after 24 hours as illustrated by the following table.

| Stabilizer Type | Separation % |
|---|---|
| No Stabilizer | 32.96 |
| 0.5 g fiber | 9.44 |
| 0.5 g beads | 2.22 |

Also, stability results when using MULTITHERM-PG1™ oil as the oil phase were recorded. Similarly, phase separation was monitored after 1, 2, 3 and 24 hrs for all the tested emulsions. When using no stabilizer and when using fiber stabilizer, the difference in stability was not as dramatic as when using kerosene in the oil phase. Over three hours, the fiber containing emulsion experienced less phase separation than the bead containing emulsion or the emulsion containing no stabilizer. Over 24 hours, the emulsions containing stabilizing particles and beads exhibited no long term reduction in phase seperation.

| Stabilizer Type | Separation % |
|---|---|
| No Stabilizer | 15.56 |
| 0.5 g fiber | 14.16 |
| 0.5 g beads | 15.56 |

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

1. A method for treating a subterranean formation traversed by a wellbore, comprising:
forming an emulsion comprising
oil,
acid, and
a water miscible nano and/or micro particulate,
wherein the forming the emulsion is prepared on the fly; and
introducing the emulsion into a wellbore.

2. The method of claim 1, wherein the particulate is a partially soluble organic acid or poly organic acid.

3. The method of claim 1, wherein the particulate is PLA, PGA, benzoic acid, citric acid, or a combination thereof.

4. The method of claim 1, wherein the acid comprises chelant-based acid system, organic acids, or a combination thereof.

5. The method of claim 1, wherein the acid comprises hydrofluoric, hydrochloric, formic, acetic, maleic, citric, or cinnamic acid or a combination thereof.

6. The method of claim 1, wherein the oil is diesel, kerosene, mineral oil, paraffin oil, vegetable oil, LPG, crude oil, benzene, xylene, toluene, or a mixture thereof.

7. The method of claim 1, wherein forming the emulsion is performed with a residence time of 30 seconds or less.

8. The method in claim 1 where the emulsion is partially created on the fly.

9. The method in claim 1 where the emulsion is fully created on the fly.

10. The method of claim 1, wherein the emulsion further comprises emulsifiers, iron control agents, H₂S scavenger, fiber, fluid loss additives, friction reducers, tacky additives, consolidating materials, scale control additives, wettability alternating additives, or combinations thereof.

11. The method of claim 1, wherein the introducing the emulsion comprises bull heading or using coiled tubing.

12. The method of claim 1, wherein the particulates comprise encapsulated oil soluble materials.

13. The method of claim 13, wherein the materials are encapsulated oil soluble resins.

14. The method of claim 1, wherein the particulates are encapsulated water soluble materials.

15. The method of claim 1, wherein the particulates are in the form of wires or tubes.

16. A method for treating a subterranean formation traversed by a wellbore, comprising:
forming an emulsion comprising
oil,
acid, and
a particulate selected from the group consisting of nutmeg, mustard, guar, or a combination thereof.
wherein the forming the emulsion is prepared on the fly; and
introducing the emulsion into a wellbore.

17. The method of claim 16, wherein the particulate is derived from a plant.

18. The method of claim 16, wherein the particulate is a nut powder or a grain powder.

19. The method of claim 16, wherein forming the emulsion is performed with a residence time of 30 seconds or less.

20. The method of claim 16, wherein the introducing the emulsion comprises bull heading or using coiled tubing.
